(19) United States
(12) Patent Application Publication
(10) Pub. No.: US 2025/0312856 A1
(43) Pub. Date: Oct. 9, 2025

(54) SYSTEMS AND METHODS RELATED TO COPING RADIUSED MOLDING

(71) Applicants: LARRY R. GRIMMER, SUSSEX, WI (US); GREGORY R. SCHMIDT, SAUKVILLE, WI (US)

(72) Inventors: LARRY R. GRIMMER, SUSSEX, WI (US); GREGORY R. SCHMIDT, SAUKVILLE, WI (US)

(21) Appl. No.: 18/935,086

(22) Filed: Nov. 1, 2024

Related U.S. Application Data
(60) Provisional application No. 63/731,150, filed on Apr. 8, 2024.

(51) Int. Cl. B23B 47/28; B23B 41/00

(52) U.S. Cl. CPC B23B 47/28; B23B 41/003; B23B 2247/10

(57) ABSTRACT

A device according to the present invention comprises a panel pivotably coupled to a base. The base includes a trough in which molding pieces are placed and the panel includes a hole through which the molding pieces may be cut using a hole saw. The base may further include a clamp to hold the panel in place and support fittings to fit the base onto the rim of a five-gallon bucket. The device greatly reduces the time spent cutting coping during construction and increases safety and efficiency.

### Related Applications

This application claims priority to U.S. Provisional Patent App. Ser. No. 63/731,150, filed Apr. 8, 2024, and entitled “E-Z cope jig,” which is incorporated herein by reference in its entirety.

### BACKGROUND OF THE INVENTION

In flooring installation, the term “coping” refers to shaping trim molding pieces that meet at a corner, usually an inside corner. When coping molding over hard surface flooring, such as hardwood, laminate, vinyl, tile, or any other type of solid surface, even professional workers who have performed the task hundreds of times generally follow the same set of steps. First, after a piece of molding is cut to length (or in the process of cutting it to length) one end of the molding needs to be undercut at an approximate −45° angle on a mitre saw. Second, that end needs to be roughly profile shaped with a coping saw to remove most of the material to allow the molding to match up to the mating piece of trim. Third, the piece must be finely profile shaped (e.g., by filing) up to the outside edge of the molding to match the trim exactly. This entire process can take anywhere from 3 minutes (for the most experienced) to 15 minutes (for the least), depending on the skill of the carpenter.

For a typical home (which can have upwards of 100 inside corners that may all require coping), this process can be unnecessarily time consuming as the carpenter must make measurements and move to and from the mitre saw with each cut. However, a specialized tool can speed up this process immensely, especially for radiused molding pieces, such as quarter round and shoe molding. Further, the normal coping process may be hazardous, as the carpenter cuts the molding pieces using a mitre saw and their hands. Finally, the normal coping process may be messy, as debris from the cutting process flies off the molding piece. Therefore, improvements in tools to aid the process of coping molding for hard surface flooring, improving speed, safety, and efficiency, are sought.

### SUMMARY OF THE INVENTION

Embodiments of systems and methods according to the present invention relate generally to methods and devices for an E-Z Cope Jig. Specifically, the present invention relates to a jig that locates and positions molding, is capable of cutting both right and left hand copes, and provides a more consistent and higher quality cut in less time than the traditional coping method.

According to an aspect of an embodiment of a device according to the present invention, the device includes a panel that has opposing face and under surfaces, a panel height extending between such surfaces and a first throughbore formed about a first throughbore axis and extending through the entire height and both surfaces. A base includes opposing top and bottom surfaces, and a base height extending between such surfaces, with a second bore (reentrant or throughbore) extending into the base through the top surface, and a trough formed into the base through the top surface, the trough extending into or through the second bore. The panel is securable (preferably at least substantially stationary) relative to the base in an orientation that provides an alignment of an extension of a longitudinal side edge of the trough at least substantially tangentially with an extension of the first throughbore, the alignment occurring in the second throughbore. In other words, a line coincident with the longitudinal side edge of the trough perpendicularly intersects an axial line coincident with the perimeter of the first throughbore, the axial line extending parallel to the first throughbore axis.

According to another aspect of an embodiment of a device according to the present invention, the panel is pivotably coupled to the base and movable between an open position and a closed position. When in the closed position, the panel under surface is arranged substantially parallel to the base top surface. The first throughbore may have a smaller diameter than the second bore, and the first throughbore axis may be at least substantially vertically aligned with a central axis of the second bore when the panel is in the closed position.

According to still another aspect of an embodiment of a device according to the present invention, the base bottom surface may include support fittings (e.g., one or more grooves) configured to receive the rim of a bucket.

According to yet another aspect of an embodiment of a device according to the present invention, the device further includes a clamp that assists in securing the panel relative to the base. The clamp may be coupled to the base top surface (and may be supported on an raised platform extension thereof), or otherwise in operative relative orientation as between the base and panel. The clamp may be movable between an engaged position (to maintain relative orientation between panel and base) and a disengaged position (allowing relative movement of the panel and base).

According to a further aspect of an embodiment of a device according to the present invention, the base and panel may be provided with mating alignment or registration structures. For instance, one of the base and panel may include a male structure, such as a leg protrusion, and the other of the base and panel may include a female slot arranged to receive the male structure to align the base and panel in the closed position.

According to still a further aspect of an embodiment of a device according to the present invention, one or more buffer members may be disposed at least partially in the trough(s) when the panel and base are in the closed position. The buffer member(s) may be elastic or inelastic, coupled to or formed integrally with the panel under surface. All buffer members may be formed of the same material or one or more may be formed from a different material.

According to yet a further aspect of an embodiment of a device according to the present invention, a bearing (e.g., static support) structure may surround the first throughbore and extend from the panel face surface. The bearing includes an extension of the first throughbore.

According to an aspect of another embodiment of a device according to the present invention, the device may, in addition to the first and second bores or alternatively to the first and second bores, include a first jig opening (or void) extending through the entirety of the panel height and a second jig opening (or void) extending at least partially into, but preferably through the entirety of, the base height. A first shoe-mold slot is formed in the base top surface, the first shoe-mold slot extending into the second jig opening, and a second shoe-mold slot formed in the base top surface, the second shoe-mold slot extending into the second jig opening from a direction opposite the first shoe-mold slot. The orientation preferably provides an alignment of the first jig opening with the second jig opening. The jig openings are generally substantially rectangular with diametrically opposed corners having a predetermined radius, the predetermined radius being less than a width of the first shoe-mold slot.

According to an aspect of a method according to the present invention, the method includes a first positioning step involving positioning a quarter-round molding piece in a trough in a base, the quarter-round molding piece having a longitudinal top edge, the top edge comprising a straight edge adjacent a radiused portion of a cross-section of the piece. A panel is positioned over the base in a second positioning step, the panel comprising a first circular or cylindrical throughbore, the positioning step comprising aligning the molding top edge proximate a first end portion of the molding piece at least substantially tangential to an extension of the first circular throughbore. A combination of the first and second positioning steps results in alignment of the molding top edge proximate a first end portion of the molding piece at least substantially tangential to an extension of the first circular throughbore. The method also includes the step of guiding a rotating hole saw through at least a portion of the first circular throughbore and the first end portion of the quarter-round piece.

According to another aspect of a method according to the present invention, the method further includes the step of supporting the base on the rim of a bucket.

According to still another aspect of a method according to the present invention, the method further includes the step of, before undertaking the guiding step, securing the panel relative to the base.

According to yet another aspect of a method according to the present invention, the method further includes the steps of repositioning the molding top edge proximate a second end portion of the molding piece at least substantially tangential to an extension of the first circular throughbore and guiding a rotating hole saw through at least a portion of the first circular throughbore and the second end portion of the quarter-round piece.

### BRIEF DESCRIPTION OF THE DRAWINGS

FIG. 1 is a perspective view of a device according to the present invention.

FIG. 2 is a top plan view of a device base according to the present invention.

FIG. 3 is a magnified partial plan view taken at circle FIG. 3 in FIG. 2.

FIG. 4 is a bottom plan view of the base of FIG. 2.

FIG. 5 is a left elevation view of the base of FIG. 2.

FIG. 6 is a right elevation view of the base of FIG. 2.

FIG. 7 is a top plan view of a panel according to the present invention.

FIG. 8 is a bottom plan view of the panel of FIG. 7.

FIG. 9 is a left elevation view of the panel of FIG. 7.

FIG. 10 is a right elevation view of the panel of FIG. 7.

FIG. 11 is a left side elevation view of the device of FIG. 1, with the panel in an open position.

FIG. 12 is a left side elevation view of the device of FIG. 1, with the panel in a closed position.

FIG. 13A is a bottom plan view of a prior art hole saw.

FIG. 13B is a partial cross-sectional view taken along line 3-3 of FIG. 13A.

FIG. 14 is an alternative cross-sectional view of a hole saw according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

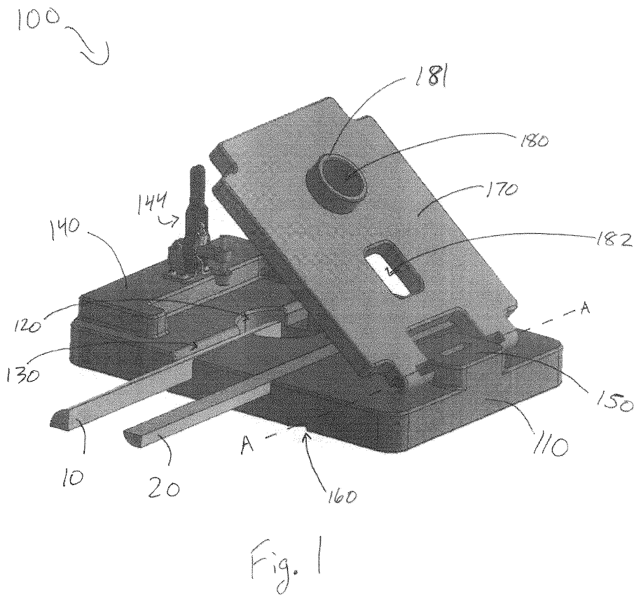

Turning now to the Figures, embodiments of devices according to the present invention may be seen. As seen in FIG. 1, a device 100 according to the present invention generally comprises a panel 170 that is generally registered (aligned) with a base 110, but moveable with respect thereto. The base 110 is configured to receive quarter-round molding 10. As used herein, “quarter-round” refers to a longitudinal molding that has a cross-section of approximately one-quarter of a circle. That is, there are two longitudinal substantially flat sides that meet to form an approximate ninety-degree angle. An outer radiused (convex) surface extends from one of the flat sides through approximately ninety degrees to the other flat side. The panel 170 is placed over the quarter-round molding 10 to hold it in place and a clamp 144 secures the panel 170 to the base 110. A top throughbore 180 in the panel 170 is preferably at least substantially coaxially aligned with a bottom throughbore 120 in the base 110 to assist alignment and passage of a hole saw to cut the quarter-round molding 10 into shape quickly and efficiently. Likewise, when the panel 170 is aligned with the base 110, a top jig opening 182 is positioned over a bottom jig opening 134 to enable coping of shoe molding 20. As used herein, “shoe molding” refers to a longitudinal molding that has a cross-section of approximately one-quarter of a circle adjacent a rectangular portion. That is, there are first and second longitudinal substantially flat sides that meet to form an approximate ninety-degree angle. An outer radiused (convex) surface extends from the first of the flat sides through approximately ninety degrees to a third flat side, which is parallel to the first. The third flat side meeting with the second flat side to form an approximate ninety-degree angle. Various components of the device 100, including the base 110 and panel 170, may be created from materials such as polycarbonate in a 3D printing process. However, due to the relatively high durability requirement for the components due to their use in construction, it is more preferable that the device 100 comprise components made of durable materials such as wood and/or worked metals like steel or machined aluminum. The device 100 drastically speeds up the process of preparing molding for installation in room corners, from approximately 3 to 15 minutes down to approximately 15 to 30 seconds, is cost effective to produce, and is easy to transport from job site to job site.

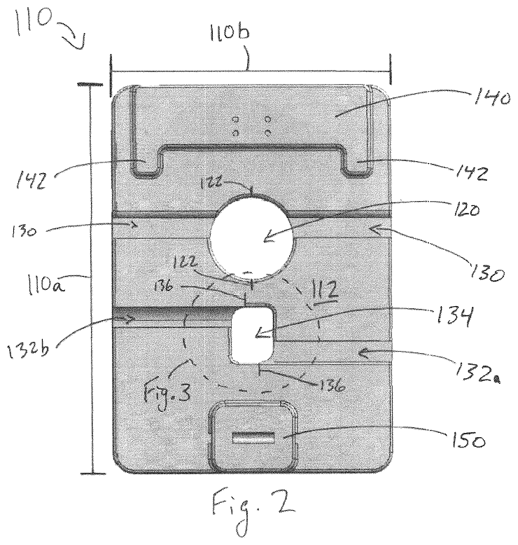

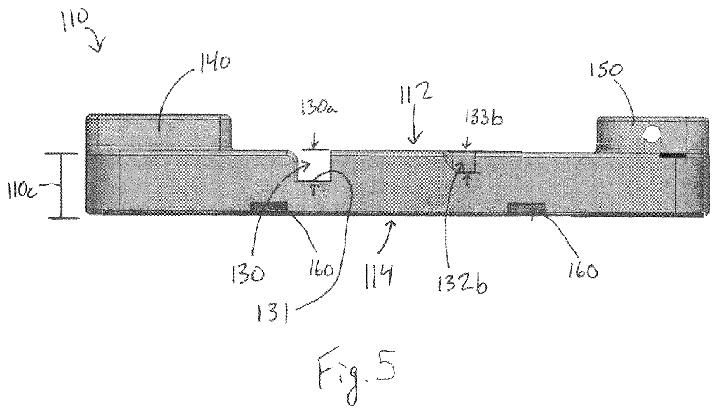

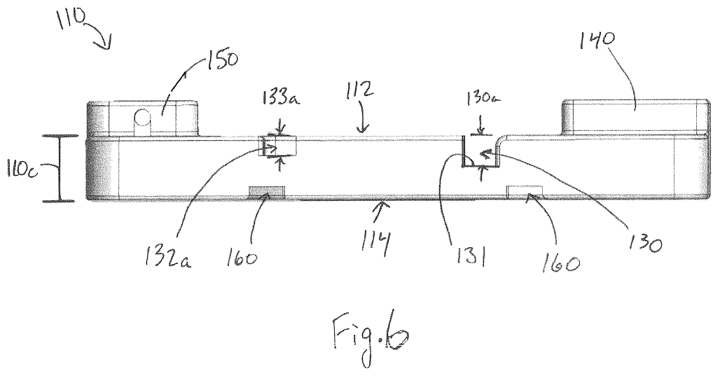

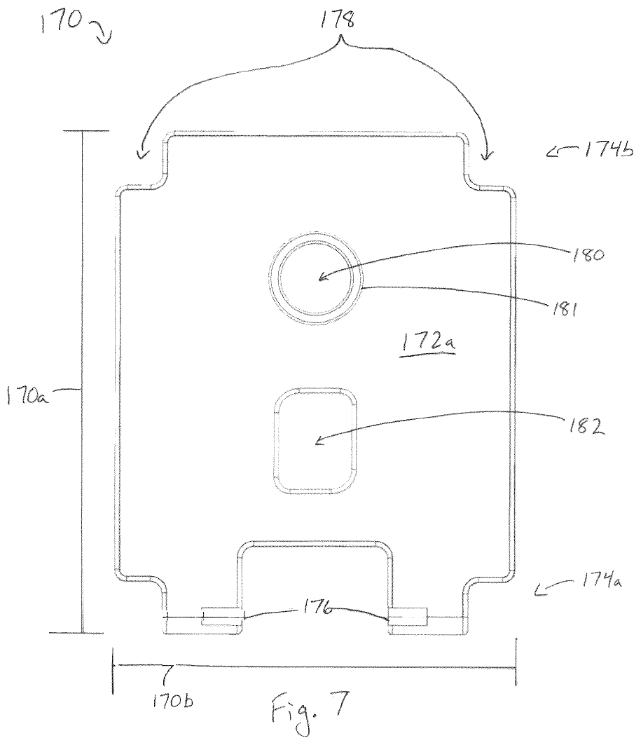

More specifically, as seen in FIGS. 2-6, the base 110 is preferably a substantially flat, solid, rectangular piece of material, preferably having rounded corners and comprising a length 110a, width 110b, and height 110c. The base 110 further preferably comprises a top side 112 opposing a bottom side 114. The bottom throughbore 120 extends through the top side 112 at least partially into, and preferably completely through, the base 110. Also extending through the top side 112 and into the base 110, and intersecting the bottom throughbore 120, is a molding trough 130. The trough 130 has a flat bottom 131 to receive one of two flat surfaces on a piece 10 of quarter-round molding. The relative alignment of the molding trough 130 will be explained further below. The trough 130 preferably extends through the full width 110b of the base 110, having open ends at each extreme of the base width 110b to allow parts of the quarter-round molding pieces 10 to extend beyond the base 110. The trough 130 also preferably comprises a depth 130a less than the height 110c of the base 110, such that the trough 130 does not extend through the base 110. The base top side 112 may also preferably include one or more molding guide lines 122, along a line preferably at about ninety degrees relative to the trough 130 and intersecting a central axis of the second throughbore. In use, when a quarter round molding piece 10 is placed in the molding trough 130, the end of the piece 10 is preferably aligned with the indicator line(s) 122.

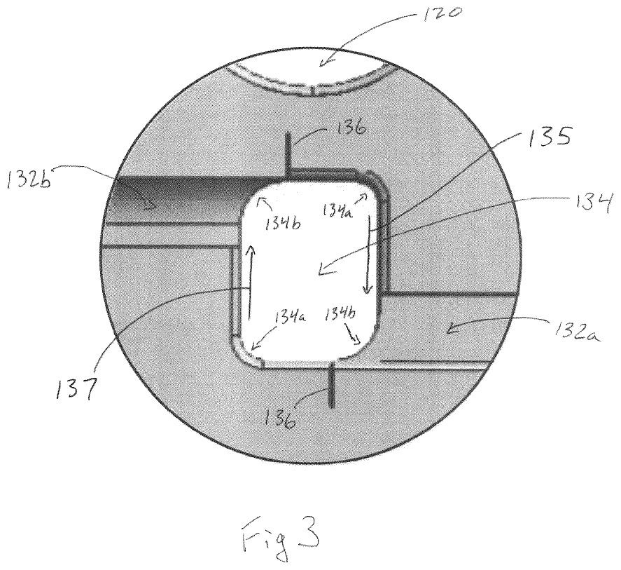

In addition to providing an interface to receive quarter-round molding for coping, the base 110 may additionally provide an interface to receive shoe molding for coping. Accordingly, a first shoe-mold slot 132a extends inward from one side of the base 110 inward to a bottom jig opening 134 and a second shoe-mold slot 132b extends inward from the opposite side of the base to the bottom jig opening 134. Similar to the second throughbore 120, the bottom jig opening 134 preferably extends through the top side 112 at least partially into, and preferably completely through, the base 110. The bottom jig opening 134 is preferably substantially rectangular, having two sets of diametrically opposed corners. A first set of corners 134a is either squared off or provided with a minimal radius (e.g., ⅛″ to ¼″). The other set of corners 134b is radiused (e.g., ½″ to ¾″) to at least substantially match a predetermined top radius of a shoe molding 20 to be trimmed. These contrasting corners 134a,b can be seen most clearly in the magnified partial view of FIG. 3. The first shoe-mold slot 132a extends tangentially from one of the second set of corners 134b and the second shoe-mold slot 132b extends from the other of the second set of corners 134b.

Like the molding trough 130, each shoe-mold slot 132a,b extends through an edge of the base 110, allowing the shoe molding pieces 20 to extend beyond the edge of the base 110 when placed in a slot 132a or b. Further, each slot 132a,b has a depth 133a,b, respectively, to allow the acceptance of the shoe molding piece 20 such that the top of the shoe molding piece 20 is substantially flush with the surrounding surface of the base top side 112, as seen in FIG. 1. However, the slots 132a,b are each preferably shaped slightly differently from each other to preferably accommodate opposing surfaces of shoe molding pieces 20. That is, the right slot 132a may generally have a rectangular cross-section, having a substantially flat bottom to accept a first flat side of the shoe molding piece 20. The left slot 132b has a substantially curved bottom to mate with a curved side of the shoe molding piece 20. This difference leads to a different style of shoe molding cut. For example, a shoe molding piece 20 placed in the right slot 132a and cut (see FIG. 3, along direction 135) along the radiused corner 134b of the second jig opening 134 results in a right inside shoe molding cut. Conversely, if the shoe molding piece 20 is placed in the left slot 132b and cut (see FIG. 3, along direction 137), the result is a left inside shoe molding cut.

Proximate the radiused corners 134b of the bottom jig opening 134, the base top side 112 preferably comprises guide lines 136. These guide lines 136 are preferably located at the end of the curve of each radiused corner 134b (where the curve 134b meets a longitudinal edge of the tangential slot 132), as seen in FIGS. 2 and 3. When a shoe mold piece 20 is placed in either the right slot 132a (curve facing up) or left slot 132b (curve facing down), the end of the shoe mold piece 20 is preferably aligned with a guide line 136 associated with the respective slot 132 in use, leaving the shoe mold piece 20 end in disposed in the second jig opening 134. When in use, the user cuts the shoe mold piece 20 as they follow the curve of the router hole radiused corner 134b, resulting in a right or left inside shoe mold cut depending which slot 132a,b is used.

Extending from, and preferably formed integrally with, proximate one end of the top side 112 of the base 110 is preferably a raised platform 140 on which a clamp 144 is fastened or secured. The clamp 144 may be any type known in the art, such as a spring clamp, bench clamp, or hold down clamp as shown in the Figures. Also provided on the top side 112 is an alignment structure to assist in aligning the panel 170 with the base 110. The alignment structure may include one or more legs 142, which may be formed integrally with the raised platform 140. The top side 112 also preferably comprises an attachment interface to cooperate with the panel 170, such as a raised bar support 150 extending from, and preferably formed integrally with, the base 110. The bar support 150 preferably retains a bar 152 rotatingly coupling the panel 170 to the base 110.

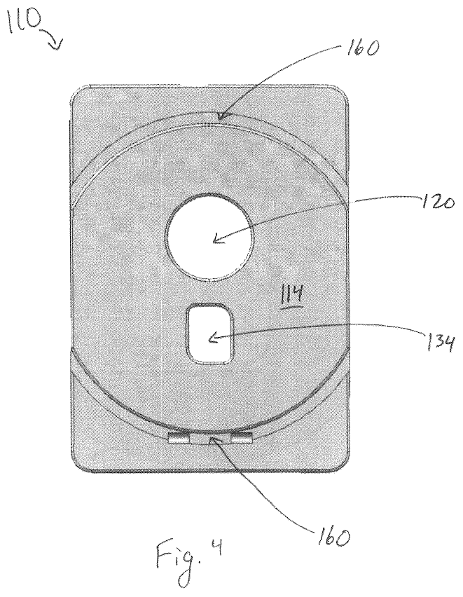

Opposing the top side 112 of the base 100, the bottom side 114 of the base 110 is preferably substantially flat, but also comprise one or more support fittings 160. These support fittings 160 preferably receive a portion of a support structure. For example, the embodiment of the support fittings 160 seen in FIGS. 4-6 are grooves formed along a circular path, with an inner edge of the groove being formed about a radius of approximately 5.5″ to about 5.75″, with about 5.6″ being preferred. An outer edge of the groove is preferably formed about a radius of approximately 5.75″ to about 6″, with about 5.9″ being preferred. In this fashion, the grooves 160 are formed and configured to receive a rim of a standard five-gallon bucket. Other embodiments of the device 100 according to the present invention may comprise support fittings 160 configured to receive the rim of different sized buckets or other edges and/or surfaces of differing support structures, such as tables, beams, stands, etc. Alternatively or additionally to the support fittings 160, the bottom side 114 may comprise one or more support structures, such as paddings, bumpers, and/or rubber feet.

Like the base 110, the panel 170 is also preferably a substantially flat, solid, rectangular piece of material, having a length 170a, width 170b, and height 170c. However, the length 170a and width 170b of the panel 170 is preferably less than the length 110a and width 110b of the base 110, such that the panel 170 can lay flat on the base 110 without extending past the sides or ends of the base 110. When hingedly affixed to and positioned over the base 110, a face side 172a of the panel 170 is preferably oriented away from the base 110, while an under-side 172b of the panel 170 is oriented toward the base 110.

The panel 170 further preferably comprises the top throughbore 180 and optionally the top jig opening 182, both extending through the panel 170. The top throughbore 180 is preferably slightly larger than, and configured to loosely accept, a specific standard sized hole saw drill bit, such as a 1″ to a 1.5″ diameter hole saw. Different embodiments of a panel 170 according to the present invention may comprise top throughbores 180 that fit other hole saw sizes and the panels 170 may be switched out as needed for the current situation. However, no matter the size of the top throughbore 180, the hole 180 should have a preferably smaller diameter than the bottom throughbore 120 of the base 110. Further, when the panel 170 is placed over the base 110, the central point of the top throughbore 180 may be aligned directly above the central point of the bottom throughbore 120, but in any event when viewed from above, an edge of the molding trough 130 preferably aligns tangentially with the curve of the top throughbore 180.

The panel face side 172a may further comprise a hole saw bearing (preferably simple bearing or guide) 181 placed about the top throughbore 180. In cutting the coping, the circular hole saw bit being used preferably does not include the central pilot bit. This may cause the hole saw drill bit to be unstable (i.e. wobbly). The bearing 181 provides stability while cutting by preventing the drill bit from moving side to side, or tending off plumb. Such bearing 181 is preferably made from hardened steel to withstand friction from the hole saw bit. The top jig opening 182 is preferably formed at least substantially the same size and shape as the bottom jig opening 134. In use to trim shoe molding 20 (preferably with a flush trim router bit with bearing), the top jig opening 182 preferably acts a router guide, to help the user accurately rout the edge of the shoe molding 20 to a specific shape following the radiused curves 134b.

At a proximal end 174a, the panel 170 preferably comprises bar connections 176 which preferably engage with the bar 152 of the base 110. The bar connections 176 facilitate the panel 170 pivoting about a longitudinal axis A of the bar 152 from an open position 171a, where the under-side 172b of the panel 170 is pivoted away from the base 110, to a closed position 171b, where the under-side 172b of the panel 170 is adjacent to or in contact with the top side 112 of the base 110. Once the quarter-round molding pieces 10 are cut, the panel 170 may also be pivoted in the reverse direction from the closed position 171b back to the open position 171a to remove the quarter-round molding pieces 10 and optionally place new pieces 10. The bar connections 176 are also preferably static about the bar 152 unless the panel 170 is acted on (i.e. moved) by the user. That is, if the device 100 is left untouched, the friction force between the bar connections 176 and the bar 152 (and further including any frictional engagement with the bar support 150) is preferably greater than the force of gravity, causing the panel 170 to preferably remain static at whatever position it is placed. However, such friction force is not so great that the panel 170 cannot move, rather the user can manually cause the panel 170 to pivot about the longitudinal axis A of the bar 152 to move between open and closed positions 171a,b.

To further facilitate the transition to the closed position 171b, the distal end 174b of the panel 170 comprises leg registration slots 178, which are notches in the panel 170 that align with the legs 142 of the raised platform 140 on the base 110. The result is that, when the panel 170 is pivoted to the closed position 171b, the leg registration slots 178 receive the legs 142 and the panel 170 is correctly aligned to a position where the first throughbore 180 is positioned directly above the second throughbore 120 (and/or sufficiently aligned with the edge(s) of the trough(s) 130) on the base 110 and the top jig opening 182, if included, is positioned directly above the second jig opening 134, if included. The inclusion of the leg registration slots 178 help align the panel 170 in the same manner every time it is used, to help ensure the cuts made to the molding pieces 10,20 will be at least substantially similar every time.

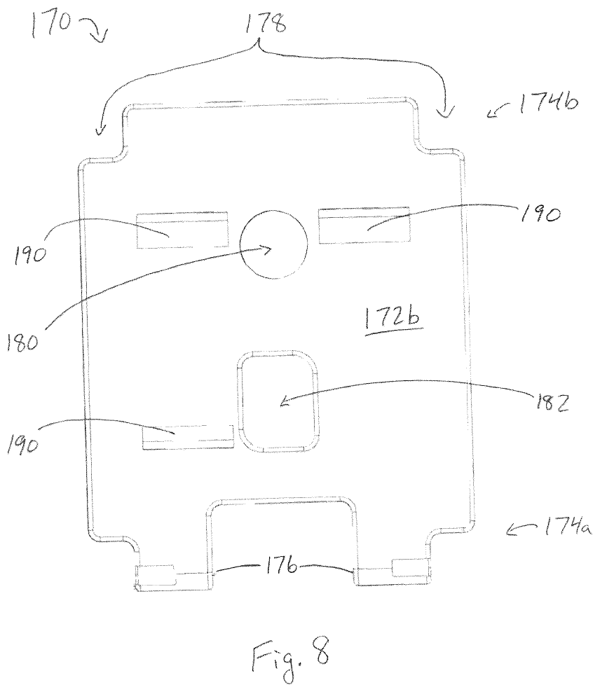

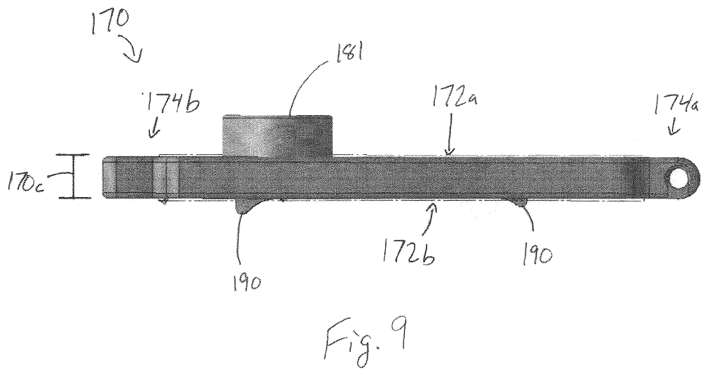

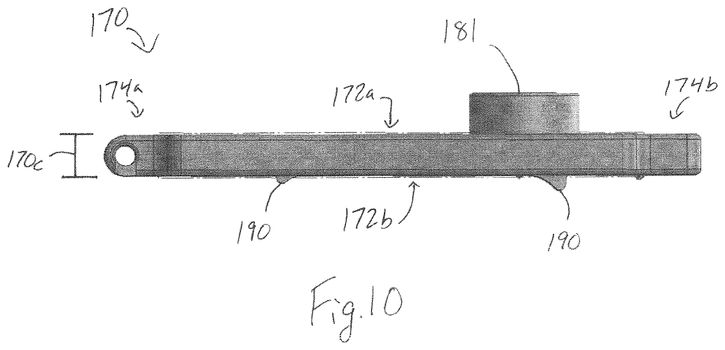

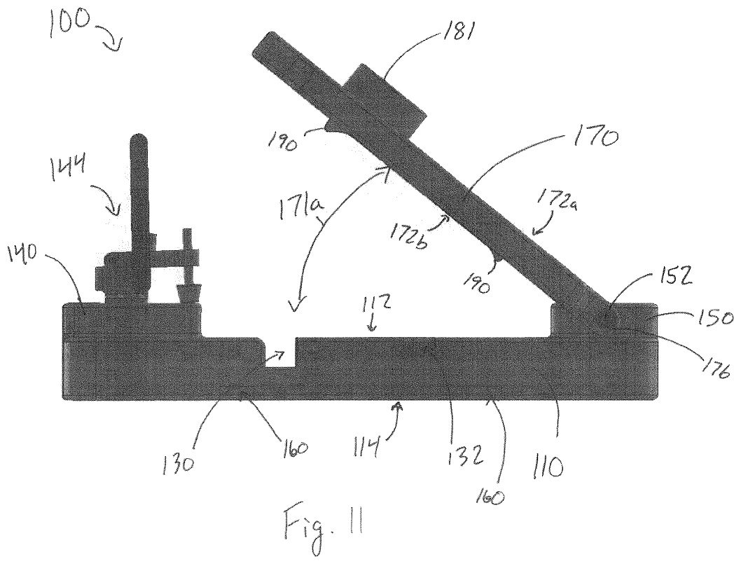

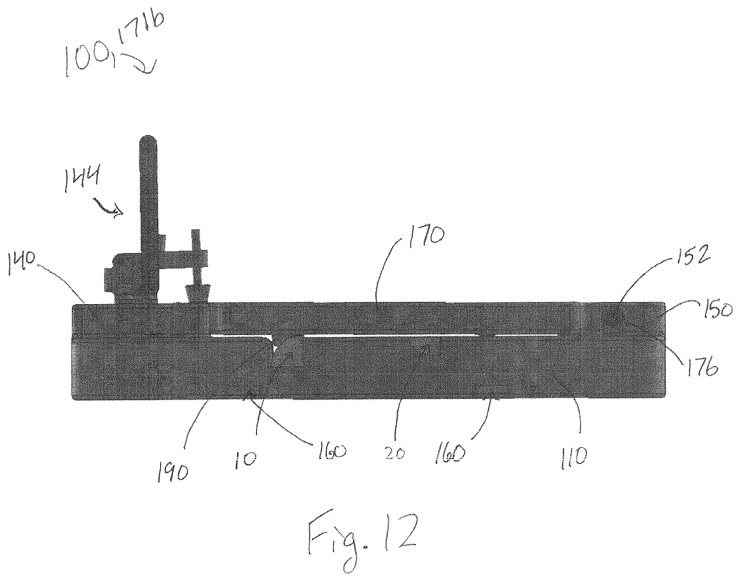

As clarified and described above, and generally understood in the art, the molding pieces 10,20 are not completely square or rectangular, but are at least partially semicircular in cross-section. This means that, when the pieces 10 are placed into a molding trough 130, the pieces 10 do not fill the trough 130 completely, rather there is at least some empty space or void left between the panel 170 and/or trough 130 and the molding piece 10,20. The result is the pieces 10 may jostle or otherwise move when cut, which can lead to imprecise or otherwise suboptimal cuts. For this reason, the under-side 172b of the panel 170 preferably further comprises one or more bumper members 190 that fill the unused space left between the molding quarter-round molding piece 10 and the panel 170 and/or trough 130 or between the shoe molding piece 20 and the router trench 132a. The bumper members 190 may be elastic or semi-elastic (i.e. it contorts its own shape to fill in the gap), such as foam or vinyl tubing, or the bumper members 190 could be inelastic (i.e. does not contort its own shape at all) and shaped specifically to substantially fill the void. Such inelastic bumper members 190 may even be formed integrally with the under-side 172b of the panel 170, as seen in FIG. 8.

In use for coping quarter-round molding, the user selects a panel 170 (or completely assembled device 100) with the first throughbore 180 sized for the desired hole saw size (usually indicated as a diameter which should be approximately twice the radius of the quarter-round molding to be coped) to be used in the cutting process. If the device 100 is not yet assembled, the user then installs the panel 170 onto the base 110 by latching the bar 152 into the bar connections 176 on the panel 170, leaving the panel 170 in an open position 171a. The device 100 is placed on a sturdy support, such as by fitting the support fittings 160 onto the edges of a five-gallon bucket, or otherwise placed on a horizontal surface such as the ground, a workbench, or a tailgate of a truck. Next, the user places one or more of the quarter-round molding pieces 10 to be cut in the molding trough 130, one of the ends of each of the one or more quarter-round molding pieces 10 being suspended over the middle of the second throughbore 120, such as over a five-gallon bucket. Directionally as shown in FIG. 1, the piece 10 is arranged to cope a right end of the piece 10, whereas opposite positioning would be used to trim a left end of the piece 10. The user then pivots the panel 170 about the bar 152 to the closed position 171b (or otherwise places the panel 170 aligned with the base 110). The bumper members 190 preferably maintain the quarter-round molding pieces 10 static and the legs 142 of the raised platform 140 correctly align with the leg registers 178 of the panel 170. Finally, the user engages the clamp 144 (or another securement mechanism) to hold the panel 170 in place. A hole saw is placed and secured (e.g., chucked) in an operative rotary apparatus (such as an electric/battery operated drill) and inserted into the bearing 181 and/or first throughbore 180. While the rotary apparatus could be activated prior to insertion of the bit into the bearing 181 and/or throughbore, activation preferably occurs after the bit is disposed therein. The hole saw preferably comprises a circular cutting blade, having a radius that is approximately twice the diameter of the quarter-round coping being cut.

In use for coping shoe molding, the user selects a panel 170 (or completely assembled device 100) with the top jig opening 182 including radiused corners 134b of a predetermined radius (usually at least approximately the radius of the top of the shoe molding to be coped, or the thickness of the molding) to be used in the cutting process. If the device 100 is not yet assembled, the user then installs the panel 170 onto the base 110 by latching the bar 152 into the bar connections 176 on the panel 170, leaving the panel 170 in an open position 171a. The device 100 is placed on a sturdy support, such as by fitting the support fittings 160 onto the edges of a five-gallon bucket, or otherwise placed on a horizontal surface such as the ground, a workbench, or a tailgate of a truck. Next, the user places a shoe molding piece 20 to be cut in the first slot 132a (height flat side down, for a right terminus coping) or the second slot 132b (height formed side down, for a left terminus coping) one of the ends of the molding piece 20 being suspended over the bottom jig opening 134, such as over a five-gallon bucket. Directionally as shown in FIG. 1, the piece 10 is arranged to cope a left end of the piece 20, whereas opposite positioning would be used to trim a right end of the piece 20. The user then pivots the panel 170 about the bar 152 to the closed position 171b (or otherwise places the panel 170 aligned with the base 110). The bumper member 190 preferably maintains the shoe molding piece 20 static (if performing a right coping) and the legs 142 of the raised platform 140 correctly align with the leg registers 178 of the panel 170. Finally, the user engages the clamp 144 (or another securement mechanism) to hold the panel 170 in place. A router bit (e.g., flush trim router bit) is placed and secured (e.g., chucked) in an operative rotary apparatus (such as an electric/battery operated router) and inserted into the top jig opening 182, the bearing of the router bit preferably extending into the bottom jig opening 134. While the rotary apparatus could be activated prior to insertion of the bit into the top jig opening 182 and/or the bottom jig opening 134, activation preferably occurs after the bit is disposed therein. The rotary apparatus is activated to cause the flush trim router bit to spin, and with a router plate supported on the panel 170, the router is guided first in a straight direction, perpendicular to a longitudinal direction of the piece 20. As the router bit follows an inner edge of the bottom jig opening 134, the bit continues through the radiused corner 134b to finish the cope.

As the molding pieces 10,20 are coped, debris preferably falls through the second throughbore 120 and, if used, into the five-gallon bucket below. After the cutting process is completed, the user releases the clamp 144, opens the panel 170, and removes the molding piece 10 for another cutting operation on the opposite end thereof, or installation into a desired corner in a building room. This process is efficient and greatly speeds up the installation process over previous coping processes. In addition, it is safer, as the user does not have to hold the pieces with their own hands while cutting, and less messy, as debris falls into the waiting bucket.

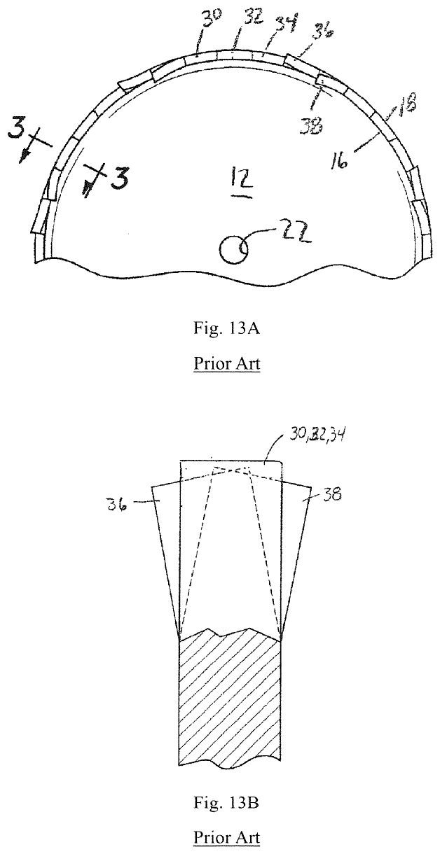

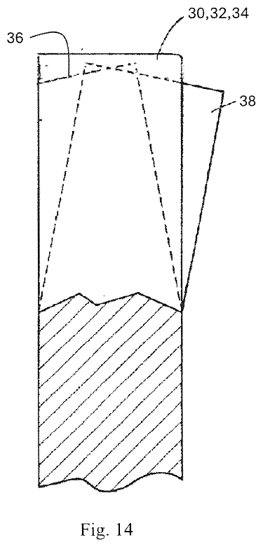

In using the device 100 as described above to cope quarter-round molding, the hole saw preferably includes a cylindrical cutting blade, which is a well-known in the art and may be purchased commercially. Referring to FIGS. 13A and 13B, a common prior art hole saw configuration, including outbound teeth 36 and inbound teeth 38, is depicted. However, such configurations have been found to cause ripping and tearing during coping, even when in use with the device 100 described above, and possible shortening of the usable lifespan of the device 100. Improved performance has been discovered, however, upon modification of such an arrangement by removing the outbound portion (e.g., by filing) of the outbound teeth 36 or not including outbound teeth at all. This blade configuration, without outbound teeth, has proven to provide cleaner coping, especially when used in conjunction with the device 100 as described above. Further, while some hole saws include a pilot drill bit in the middle of the circular cutting blade, it may be preferable when using the present device 100 and/or modified cutting blade to not install the pilot drill bit within the cutting blade.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention.

What is claimed is:

1. A device comprising:
a panel comprising a face surface and an under surface spaced by a panel height and a first throughbore extending entirely through the panel height; and
a base comprising a top surface and a bottom surface spaced by a base height, a second bore extending into the base through the top surface; and
a trough formed in the base top surface, the trough extending through the second bore,
wherein, the panel is securable relative to the base in an orientation that provides an alignment of an extension of a longitudinal side edge of the trough at least substantially tangentially with an extension of the first throughbore, the alignment occurring in the second throughbore.

2. The device of claim 1, wherein the panel is pivotably coupled to the base and movable between an open position and a closed position.

3. The device of claim 2, wherein the first throughbore has a smaller diameter than the second bore, and a center point of the first throughbore vertically aligns with a center point of the second bore when the panel is in the closed position.

4. The device of claim 1, wherein the second bore extends entirely through the base height.

5. The device of claim 1, wherein the base bottom surface comprises support fittings configured to receive the rim of a bucket.

6. The device of claim 1, further comprising a clamp coupled to the base top surface, the clamp movable between engaged and disengaged conditions.

7. The device of claim 6, wherein the base top surface further comprises a raised platform to which the clamp is mounted.

8. The device of claim 1, further comprising mating alignment structures provided on the base and the panel.

9. The device of claim 8, wherein the alignment structure comprises at least one leg on the base and at least one slot in the panel.

10. The device of claim 1, further comprising at least one buffer member disposed on the panel under surface.

11. The device of claim 10, wherein the buffer member is elastic.

12. The device of claim 10, wherein a plurality of buffer members are disposed on the panel under surface and wherein at least one buffer member is elastic and at least one buffer member is inelastic.

13. The device of claim 1, wherein the panel face surface further comprises a bearing structure surrounding the first throughbore and extending from the panel face surface.

14. The device of claim 1, further comprising:
a first jig opening extending through the entirety of the panel height;
a second jig opening extending through the entirety of the base height;
a first shoe-mold slot formed in the base top surface, the first shoe-mold slot extending into the second jig opening, and a second shoe-mold slot formed in the base top surface, the second shoe-mold slot extending into the second jig opening from a direction opposite the first shoe-mold slot,
wherein the orientation also provides an alignment of the first jig opening with the second jig opening.

15. A device comprising:
a panel comprising a face surface and an under surface spaced by a panel height and a first jig opening extending entirely through the panel height; and
a base comprising a top surface and a bottom surface spaced by a base height, a second jig void extending into the base through the top surface, a first shoe-mold slot formed in the base top surface, the first shoe-mold slot extending into the second jig void, and a second shoe-mold slot formed in the base top surface, the second shoe-mold slot extending into the second jig void from a direction opposite the first shoe-mold slot,
wherein, the panel is securable relative to the base in an orientation that provides an alignment of the first jig opening with the second jig void.

16. The device of claim 15, wherein the first jig opening and the second jig void are generally substantially rectangular with diametrically opposed corners having a predetermined radius, the predetermined radius being less than a width of the first shoe-mold slot.

17. A method comprising the steps of:
in a first positioning step, positioning a quarter-round molding piece in a trough in a base, the quarter-round molding piece having a longitudinal top edge, the top edge comprising a straight edge adjacent a radiused portion of a cross-section of the piece;
in a second positioning step, positioning a panel over the base, the panel comprising a first circular throughbore, a combination of the first and second positioning steps resulting in alignment of the molding top edge proximate a first end portion of the molding piece at least substantially tangential to an extension of the first circular throughbore;
guiding a rotating hole saw through at least a portion of the first circular throughbore and the first end portion of the quarter-round piece.

18. The method of claim 17, further comprising the step of:
supporting the base on the rim of a bucket.

19. The method of claim 17, further comprising the step of:
before the guiding step, securing the panel to the base.

20. The method of claim of claim 17, further comprising the steps of:
repositioning the molding top edge proximate a second end portion of the molding piece at least substantially tangential to an extension of the first circular throughbore;
guiding a rotating hole saw through at least a portion of the first circular throughbore and the second end portion of the quarter-round piece.
